(19) United States
(12) Patent Application Publication
(10) Pub. No.: US 2025/0212030 A1
(43) Pub. Date: Jun. 26, 2025

(54) MINIMIZATION OF DRIVE TESTS FOR MULTICAST / BROADCAST SERVICES IN NEW RADIO

(71) Applicant: Nokia Technologies Oy, Espoo (FI)

(72) Inventors: Ugur Baran ELMALI, Munich (DE); Guillaume DECARREAU, Munich (DE); David NAVRÁTIL, Espoo (FI); Malgorzata TOMALA, Wroclaw (PL); Benoist Pierre SEBIRE, Tokyo (JP)

(21) Appl. No.: 18/850,194

(22) PCT Filed: Apr. 1, 2022
(86) PCT No.: PCT/EP2022/058774

§ 371 Date: Sep. 24, 2024

(51) Int. Cl. H04W 24/08; H04L 12/18; H04W 24/10

(52) U.S. Cl. CPC H04W 24/08; H04L 12/1868; H04L 12/189; H04W 24/10

(57) ABSTRACT

According to an aspect, there is provided an apparatus for a terminal device. The apparatus is configured to perform the following. The apparatus receives from an access node minimization of drive tests, MDT, measurement configuration for one or more multicast and broadcast services, MBS. Then, the apparatus performs MDT measurements on broadcast transmissions for the one or more MBS associated with one or more cells based on the received MDT measurement configuration. Finally, the apparatus transmits an MDT report, formed based on the received MDT measurement configuration, to an access node. The MDT report comprises at least information on results of the MDT measurements. The results of the MDT measurements are indexed, in the MDT report, based on one or more cell identifiers of the one or more cells.

### TECHNICAL FIELD

Various embodiments relate to wireless communications.

### BACKGROUND

Minimization of drive tests (MDT) is a standardized mechanism implemented in many current wireless communication systems (e.g., 5G communication systems). MDT enables network operators to utilize terminal devices within the network for performing radio measurements and acquiring associated location information in order to assess network performance. The use of MDT serves to reduce the need for traditional drive tests. An MDT mechanism has been defined, for example, for Multicast Broadcast Single Frequency Network (MBSFN) Long Term Evolution (LTE) deployments. However, said MDT mechanism for MBSFN LTE is not suitable for use in New Radio deployments using MBSFN due to differences between LTE and NR.

### SUMMARY

According to an aspect, there is provided an apparatus for a terminal device of a wireless communication network, the apparatus comprising:
at least one processor; and
at least one memory including computer program code;
the at least one memory and the computer program code configured, with the at least one processor, to cause the apparatus at least to perform:
receiving from an access node of the wireless communication network, minimization of drive tests, MDT, measurement configuration for one or more multicast and broadcast services, MBS;
performing MDT measurements on broadcast transmissions for the one or more MBS associated with one or more cells of the wireless communication network based on the received MDT measurement configuration; and
transmitting an MDT report, formed based on the received MDT measurement configuration, to the access node or to another access node of the wireless communication network, wherein the MDT report comprises at least information on results of the MDT measurements on the broadcast transmissions for the one or more MBS, and wherein the results of the MDT measurements are indexed, in the MDT report, based on one or more cell identifiers of the one or more cells.

According to an aspect, there is provided an apparatus for an access node of a wireless communication network, the apparatus comprising:
at least one processor; and
at least one memory including computer program code;
the at least one memory and the computer program code configured, with the at least one processor, to cause the apparatus at least to perform:
transmitting, to a terminal device of the wireless communication network, an MDT measurement configuration for one or more MBS, wherein the MDT measurement configuration defines a configuration for the terminal device for performing MDT measurements on broadcast transmissions for the one or more MBS associated with one or more cells of the wireless communication network and forming an MDT report for transmission to the access node or another access node of the wireless communication network, the MDT report comprising at least information on results of the MDT measurements of the broadcast transmissions for the one or more MBS, the results of the MDT measurements being indexed, in the MDT report, based on one or more cell identifiers of the one or more cells.

According to an aspect, there is provided a method comprising:
receiving, by a terminal device of a wireless communication network, from an access node of the wireless communication network, an MDT measurement configuration for one or more MBS;
performing, by the terminal device, MDT measurements on broadcast transmissions for the one or more MBS associated with one or more cells of the wireless communication network based on the received MDT measurement configuration; and
transmitting, by the terminal device, an MDT report, formed based on the received MDT measurement configuration, to the access node or to another access node of the wireless communication network, wherein the MDT report comprises at least information on results of the MDT measurements on the broadcast transmissions for the one or more MBS, and wherein the results of the MDT measurements are indexed, in the MDT report, based on one or more cell identifiers of the one or more cells.

According to an aspect, there is provided a method comprising:
transmitting, by an access node of a wireless communication network, to a terminal device of the wireless communication network, an MDT measurement configuration for one or more MBS, wherein the MDT measurement configuration defines a configuration for the terminal device for performing MDT measurements on broadcast transmissions for the one or more MBS associated with one or more cells of the wireless communication network and forming an MDT report for transmission to an access node of the wireless communication network, the MDT report comprising at least information on results of the MDT measurements of the broadcast transmissions for the one or more MBS, the results of the MDT measurements being indexed, in the MDT report, based on one or more cell identifiers of the one or more cells.

According to an aspect, there is provided a computer program comprising instructions for causing an apparatus as a terminal device in a wireless communication network to perform at least the following:
receiving from an access node of the wireless communication network, an MDT measurement configuration for one or more MBS;
performing MDT measurements on broadcast transmissions for the one or more MBS associated with one or more cells of the wireless communication network based on the received MDT measurement configuration; and
transmitting an MDT report, formed based on the received MDT measurement configuration, to the access node or to another access node of the wireless communication network, wherein the MDT report comprises at least information on results of the MDT measurements on the broadcast transmissions for the one or more MBS, and wherein the results of the MDT measurements are indexed, in the MDT report, based on one or more cell identifiers of the one or more cells.

According to an aspect, there is provided a computer program comprising instructions for causing an apparatus as an access node of a wireless communication network to perform at least the following:
transmitting, to a terminal device of the wireless communication network, an MDT measurement configuration for one or more MBS, wherein the MDT measurement configuration defines a configuration for the terminal device for performing MDT measurements on broadcast transmissions for the one or more MBS associated with one or more cells of the wireless communication network and forming an MDT report for transmission to an access node of the wireless communication network, the MDT report comprising at least information on results of the MDT measurements of the broadcast transmissions for the one or more MBS, the results of the MDT measurements being indexed, in the MDT report, based on one or more cell identifiers of the one or more cells.

According to an aspect, there is provided the subject matter of the independent claims. Embodiments are defined in the dependent claims.

One or more examples of implementations are set forth in more detail in the accompanying drawings and the description below. Other features will be apparent from the description, drawings and the claims.

### BRIEF DESCRIPTION OF DRAWINGS

In the following, embodiments will be described in greater detail with reference to the attached drawings, in which

FIG. 1 illustrates exemplified wireless communication systems;

FIGS. 2A, 2B, 3 and 4 illustrate exemplary processes according to embodiments; and

FIGS. 5 and 6 illustrate apparatuses according to embodiments.

### DETAILED DESCRIPTION OF SOME EMBODIMENTS

The following embodiments are only presented as examples. Although the specification may refer to “an”, “one”, or “some” embodiment(s) and/or example(s) in several locations of the text, this does not necessarily mean that each reference is made to the same embodiment(s) or example(s), or that a particular feature only applies to a single embodiment and/or example. Single features of different embodiments and/or examples may also be combined to provide other embodiments and/or examples.

In the following, different exemplifying embodiments will be described using, as an example of an access architecture to which the embodiments may be applied, a radio access architecture based on long term evolution advanced (LTE Advanced, LTE-A) or new radio (NR, 5G), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

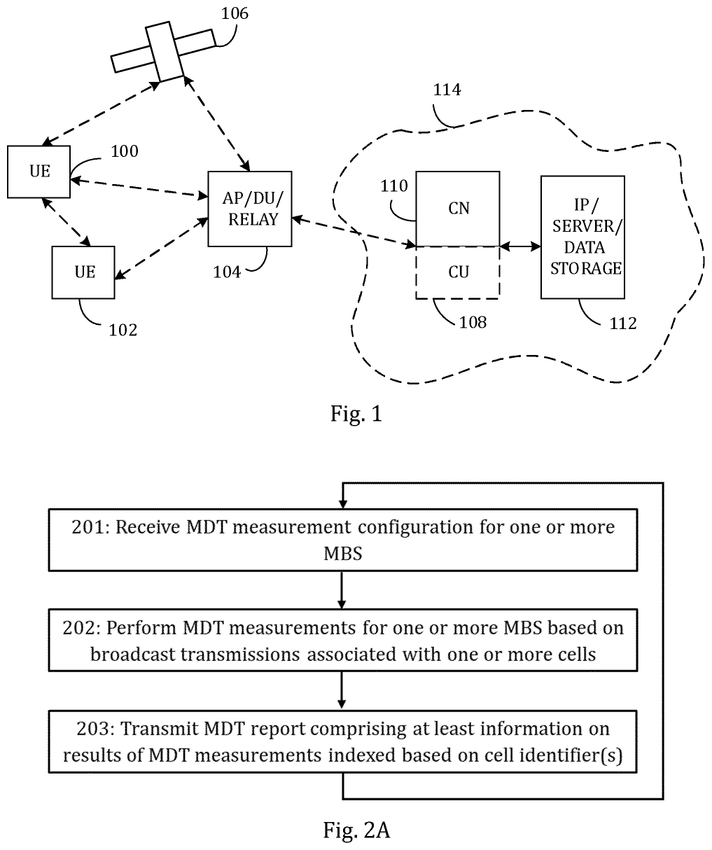

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 100 and 102 configured to be in a wireless connection on one or more communication channels in a cell with an access node (such as (e/g)NodeB) 104 providing the cell. The physical link from a user device to a (e/g)NodeB is called uplink or reverse link and the physical link from the (e/g)NodeB to the user device is called downlink or forward link. It should be appreciated that (e/g)NodeBs or their functionalities may be implemented by using any node, host, server or access point etc. entity suitable for such a usage.

A communications system typically comprises more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc.

The (e/g)NodeB may be divided, in some cases, into two or more physical entities comprising a centralized unit (CU) 108 and at least one distributed unit (DU) 104. The CU may provide support for the higher layers of the protocol stack such as service data adaption protocol (SDAP), packet data convergence protocol (PDCP) and radio resource control (RRC) while the DU may provide support for the lower layers of the protocol stack such as radio link control (RLC), medium access control (MAC) and physical layer.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements controlling physical entities). CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

It should be understood that, in FIG. 1, user devices are depicted to include 2 antennas only for the sake of clarity. The number of reception and/or transmission antennas may naturally vary according to a current implementation.

Additionally, although the apparatuses have been depicted as single entities, different units, processors and/or memory units (not all shown in FIG. 1) may be implemented.

5G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications, including vehicular safety, different sensors and real-time control. 5G is expected to have multiple radio interfaces, namely below 6 GHz, cmWave and mmWave, and also being integradable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, or utilise services provided by them. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 104) and non-real time functions being carried out in a centralized manner (in a centralized unit, CU 108).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite 106 in the mega-constellation may cover several satellite-enabled network entities that create on-ground cells. The on-ground cells may be created through an on-ground relay node 104 or by a gNB located on-ground or in a satellite.

It is obvious for a person skilled in the art that the depicted system is only an example of a part of a radio access system and in practice, the system may comprise a plurality of (e/g)NodeBs, the user device may have an access to a plurality of radio cells and the system may comprise also other apparatuses, such as physical layer relay nodes or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto-or picocells. The (e/g)NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

6G networks are expected to adopt flexible decentralized and/or distributed computing systems and architecture and ubiquitous computing, with local spectrum licensing, spectrum sharing, infrastructure sharing, and intelligent automated management underpinned by mobile edge computing, artificial intelligence, short-packet communication and blockchain technologies. Key features of 6G will include intelligent connected management and control functions, programmability, integrated sensing and communication, reduction of energy footprint, trustworthy infrastructure, scalability and affordability. In addition to these, 6G is also targeting new use cases covering the integration of localization and sensing capabilities into system definition to unifying user experience across physical and digital worlds.

The system of FIG. 1 may be a (5G NR or 6G) communication system configured to support Multicast and Broadcast Services (MBS). The MBS mechanism as used in the system may be based on Single-Cell Point-To-Multipoint (SC-PTM) transmissions. In SC-PTM, MBS transmissions are performed cell specifically. In such a system, any of the terminal devices 100, 102 operating in Radio Resource Control (RRC) connected mode may be able to receive message transmitted using a first MBS delivery mode (or MBS delivery mode 1) corresponding to multicast while all terminal device 100, 102 operating in any RRC operating mode may be able to receive messages transmitted using a second MBS delivery mode (or MBS delivery mode 2) corresponding to broadcast. MBS delivery mode 1 may provide transport blocks (TBs) both in point-to-multipoint (PTM) or point-to-point (PTP) manner to the terminal devices 100, 102. Such a system may lack hybrid automatic repeat request (HARQ) or any other feedback mechanism for broadcast transmissions (though such a feedback mechanism may be available for multicast transmissions). The broadcast transmissions may be made using a fixed modulation and coding scheme (MCS) without dynamic link adaptation. However, (blind) retransmissions or repetitions may be possible for broadcast transmissions.

The (5G NR or 6G) system of FIG. 1 may use Multicast Traffic Channel (MTCH) and Multicast Control Channel (MCCH) as logical channels to provide broadcast transmissions. MCCH provides the control information to decode the broadcast data that is transmitted using the MTCH. Same transport and physical channels with unicast (namely, downlink shared channel, DL-SCH, and physical data shared channel, PDSCH) may be utilized also for broadcast transmissions. Transport blocks containing MCCH may be transmitted via PDSCH by scrambling their cyclic redundancy check (CRC) using a separate MCCH-radio network temporary identifier (MCCH-RNTI). Similarly, MTCH may be transmitted via PDSCH using a group RNTI (G-RNTI).

The system of FIG. 1 may support a Minimization of Drive Tests (MDT) framework (or specifically NR MDT framework). Minimization of drive tests (MDT) is a framework or mechanism for enabling network operators to utilize terminal devices within the network for performing radio measurements and acquiring associated location-based information in order to assess network performance. The use of MDT serves to reduce the need for traditional drive tests. Such traditional drive tests typically use a motor vehicle containing mobile radio network air interface measurement equipment for measuring and assessing various parameters relating, e.g., to the coverage, capacity and Quality of Service (QoS) of the mobile radio network.

NR MDT framework is based on Trace and Control Plane based architecture. MDT originates in Orchestration and Management (OAM) layer, where the MDT configuration (i.e., Trace Activation) starts. Measurements are configured to the terminal device via RRC signalling, following Network Management. MDT reports that come from a terminal device 100, 102 to the access node 104 may be forwarded to a trace collection entity of the core network 110.

Three different MDT data collection modes may be defined for the (5G NR or 6G) system of FIG. 1.

A first MDT data collection mode (“immediate MDT mode”) is usable by terminal devices operating in RRC connected mode. The first MDT data collection mode may be applicable to NR and EN-DC (Evolved-Universal Terrestrial Radio Access-New Radio). The term EN-DC refers to E-UTRA NR Dual connectivity. In the first MDT data collection mode, radio measurements are carried out (i.e., data is collected) and reported back to an access node in real time (i.e., without delay).

A second MDT data collection mode (“logged MDT mode”) is usable by terminal devices operating in RRC idle mode or RRC inactive mode. In the second MDT data collection mode, radio measurements are carried out (i.e., data is collected) but the reporting does not occur in real time (i.e., there may be a significant delay between the radio measurement and the reporting of the radio measurement). Specifically, the terminal device may start collecting the data (i.e., perform the radio measurements) upon transition to RRC idle or inactive mode and report the availability of MDT data (i.e., results of radio measurements) when returning to RRC connected mode (e.g., using UEInformation procedure). To enable the reporting of the availability of MDT data, availability bit may be included within RRCSetupComplete, RRCResumeComplete, RRCReconfigurationComplete and/or RRCReestablishment-Complete message. Subsequently, an (NR) MDT report (comprising, e.g., serving/neighboring cell radio measurements, location information, time stamp, and/or events/failures records) may be transmitted by the terminal device to an access node. The second MDT data collection mode may be configured to the terminal device using a dedicated (RRC) measurement configuration message (namely, an RRC LoggedMeasurementConfiguration message). The trigger for reporting the results of the radio measurements may be a periodic trigger or event-based trigger (e.g., an A2-like event or an out of coverage event). A2 event corresponds to an event which is triggered when a sum of signal quality (e.g., RSRP or RSRQ) for a serving cell and a pre-defined hysteresis parameter falls below a pre-defined threshold.

A third MDT data collection mode (“deferred reporting mode”) is triggered by a pre-defined event (e.g., a detected radio link failure or a detected connection establishment failure).

In some embodiments, at least the second MDT data collection mode may be defined for the system of FIG. 1.

While MDT report for Multimedia Broadcast Multicast Service (MBMS) has been defined for LTE MBSFN deployments, no such definition exists for NR deployments. In case of NR, there are significant changes in multicast/broadcast architecture, in addition to the changes resulting from the network technology itself (NR compared to LTE).

One of the main differences between NR MBS and LTE MBMS is the usage of DL-SCH and PDSCH, in place of dedicated channels as used with LTE MBMS. Moreover, MBSFN is transparent to the terminal device. Therefore, the terminal device has no information on any MBSFN area.

At least due to above reasons, MDT report from LTE MBMS cannot be used for optimizing the network in NR. Hence, there exists a need for a solution enabling the network to successfully perform optimizations for broadcast transmissions using an MDT report designed specifically for the needs of 5G NR MBS framework.

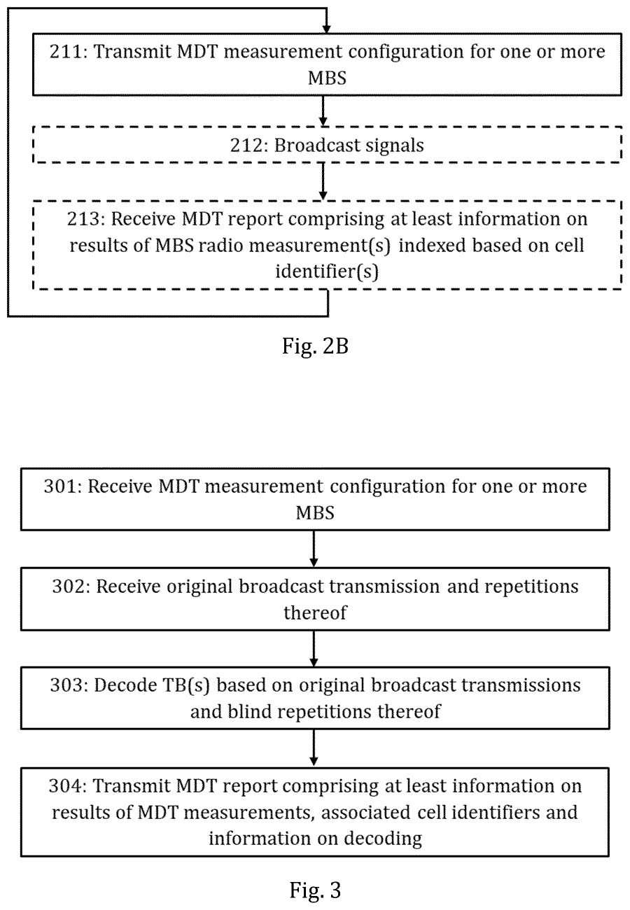

FIGS. 2A and 2B illustrate processes according to embodiments for performing MDT measurements and reporting thereof. The process of FIG. 2A may be carried out by a terminal device or a part of the terminal device. Said terminal device be either of the terminal devices 100, 102 of FIG. 1. The process of FIG. 2B may be carried out by an access node or a part of the access node. Said access node may be the access node 104 of FIG. 1. In the following, the entity carrying out the processes is called an apparatus for brevity.

Referring to FIG. 2A, the apparatus initially receives, in block 201, an MDT measurement configuration for one or more MBS from an access node of a wireless communication network (e.g., a 5G NR wireless communication network). The wireless communication network may be the same wireless communication network to which the terminal device is connected. The apparatus may configure itself based on the MDT measurement configuration message. The MDT measurement configuration defines a configuration for the terminal device for performing, fully or in part, the actions to be described in connection with blocks 202, 203 in detail. Namely, the MDT measurement configuration may define at least a configuration for the terminal device for performing MDT measurements on broadcast transmissions for the one or more MBS associated with one or more cells of the wireless communication network (block 202) and for forming an MDT report for transmission to the access node or another access node of the wireless communication network (block 203). The MDT measurement configuration may be comprised in an MDT measurement configuration message which may be an RRC message.

The MDT measurement configuration may define a trigger for reporting the results of the MDT measurements. Said trigger may be a periodic trigger or an event-based trigger (e.g., an A2-like event or an out of coverage event).

The MDT measurement configuration may define one or more first (averaging) parameters for the averaging carried out when (blind) repetitions of multiple different broadcast transmissions are received by the terminal device (as described in detail in connection with FIG. 3).

Additionally or alternatively, the MDT measurement configuration may comprise one or more second (averaging) parameters for determining an average MCS index.

The apparatus performs or causes performing, in block 202, MDT measurements for the one or more MBS based on broadcast transmissions (of transport blocks) associated with one or more cells of the wireless communication network based on the received MDT measurement configuration. In other words, the broadcast transmissions may be received from one or more access nodes serving, respectively, one or more cells of the wireless communication network. Thus, the apparatus performs or causes performing MDT measurements while visiting one or more cells. In general, one or more MDT measurements may be performed per visited cell. The terminal device (being or comprising the apparatus) may be assumed to operate, during the MDT measurements in block 202, in an RRC idle, inactive or connected operating mode and/or using MBS delivery mode 1 and/or 2.

The MDT measurements are carried out on a per cell basis (i.e., separately for each cell). In other words, each of the MDT measurements may be associated with or mapped to a particular (camped) cell identifier identifying a cell associated with the given MDT measurement.

In some embodiments, the apparatus may specifically perform or cause performing, in block 202, measurements of reference signal received power (RSRP) and/or reference signal received quality (RSRQ) based on the broadcast transmissions. Here, the broadcast transmissions may correspond to or comprise one or more reference signals of a pre-defined type. The pre-defined type of the one or more reference signals may be, e.g., a synchronization signal block (SSB) or a tracking reference signal (TRS).

In particular, TRS may be useful in the context of terminal device transparent MBSFN. SSBs are cell-specific transmissions and thus they are not, in general, expected to be synchronized between neighboring cells. However, TRSs are highly configurable. Therefore, it is possible to configure same TRS resources (time-frequency resources) from the cells in the MBSFN area so that the terminal device would indeed measure the sum of the signals synchronously transmitted by the cells of a particular MBSFN area.

In some embodiments, the MDT measurements performed in block 202 may comprise, additionally or alternatively, various measurements relating to decoding of at least one transport block contained in the broadcast transmissions, as will be described in further detail in connection with FIG. 3.

In some embodiments, the one or more cells may comprise a plurality of cells. In other words, the apparatus (or the terminal device) may receive broadcast transmissions from multiple cells over time, e.g., due to mobility.

In addition to being performed on a per cell basis, the MDT measurements in block 202 may be performed on a per G-RNTI basis (i.e., separately for each G-RNTI) when MTCH is employed and/or on a per MCCH-RNTI basis (i.e., separately for each MCCH-RNTI) when MCCH is employed so as to differentiate between different services and control/data plane. Here, it may be assumed that the terminal device (or the apparatus) is configured with one or more G-RNTIs (or a plurality of G-RNTIs) and/or with one or more MCCH-RNTIs (or a plurality of MCCH-RNTIs). As described above, transport blocks containing MCCH may be transmitted by access node(s) via PDSCH by scrambling their cyclic redundancy check (CRC) using a MCCH-RNTI (of the terminal device) while transport blocks containing MTCH may be transmitted by access node(s) via PDSCH with the CRC scrambled using a G-RNTI. The apparatus (or the terminal device) may perform descrambling or decoding of received broadcast transmissions using the one or more G-RNTIs and/or the one or more MCCH-RNTIs configured to the terminal device. The apparatus may log (i.e., store to a database) results of MTCH measurements for each G-RNTI configured to the terminal device and/or results of MCCH measurements for each MCCH-RNTI configured to the terminal device.

Thus, the MDT measurements as defined in block 202 may comprise:
one or more MDT measurements on the broadcast transmissions for the one or more MBS associated with one or more MTCHs, wherein the one or more MTCHs are associated, respectively, with one or more G-RNTIs configured to the terminal device (and used for reception of the broadcast transmissions); and/or
one or more MDT measurements on the broadcast transmissions for the one or more MBS associated with one or more MCCHs, wherein the one or more MCCHs are associated, respectively, with one or more MCCH-RNTIs configured to the terminal device (and used for reception of the broadcast transmissions).

In other words, each MDT measurement may be associated with a particular G-RNTI or a particular MCCH-RNTI. Each of the MDT measurements may also in these cases be associated with a particular cell in which the measurement in question was performed.

In some embodiments, the MDT measurements on the broadcast transmissions for the one or more MBS associated with the one or more cells of the wireless communication network may be performed in block 202 while the terminal device operates in MBS delivery mode 1 and/or MBS delivery mode 2 (as defined above). In other words, all of the MDT measurements may have been performed when operating in MBS delivery mode 1 or in MBS delivery mode 2 or some of the MDT measurements may have been performed when operating in MBS delivery mode 1 and others while operating in MBS delivery mode 2.

In some embodiments, the apparatus may store the results of the MDT measurements (and further information associated with the one or more MDT measurements such as one or more cell identifiers, one or more G-RNTIs, one or more MCCH-RNTIs, one or more MBS delivery modes and/or one or more MCS indices used for decoding) to a database. The results of the MDT measurements may be indexed (or ordered or organized), in the database, based on the one or more cell identifiers, one or more G-RNTIs, one or more MCCH-RNTIs, MBS delivery modes and/or one or more MCS indices used for decoding. Said database may be an internal or external database of the apparatus or an internal or external database of the terminal device. This process may be equally called logging. The logged information may be stored at least for a pre-defined amount of time (e.g., 48 hours) following the logging.

The apparatus transmits or causes transmitting, in block 203, an MDT report (for the one or more MBS) to an access node of the wireless communication network. This access node may or may not be the access node from which the MDT measurement configuration was received and/or an access node involved in the one or more MDT measurements. The MDT report is formed by the apparatus, at least in part, based on the MDT measurement configuration. Here, the MDT report comprises at least information on results of the MDT measurements (or at least some of them). The results of the MDT measurements are indexed (or ordered or organized), in the MDT report, based at least on one or more cell identifiers of the one or more cells. The one or more cell identifiers of the one or more cells may be comprised in the MDT report. In some cases (e.g., when the one or more cell identifiers consist of a single cell identifier), the one or more cell identifiers may be omitted from the MDT report. In other words, the results of each (or at least one) of the MDT measurements may be associated with or tagged to one of the one or more cell identifiers in the MDT report so that it may discerned, based on the MDT report, which MDT measurement result is related to which cell. The results of the MDT measurements may correspond to, for example, to measured values of RSRP, RSRQ and/or BLER. The one or more cell identifiers may be, for example, cell global identifiers (CGIs).

In some embodiments, the MDT report comprises information on the pre-defined type(s) of the reference signals associated with the measurements of the RSRP and/or RSRQ (e.g., SSB or TRS). The results of the measurements of the RSRP and/or RSRQ may be indexed (or ordered or organized), in the MDT report, based on the pre-defined type of the reference signals (if multiple different types are used).

If the MDT measurements (or at least some of them) are carried out on a per G-RNTI basis as described in connection with block 202, results of the one or more MDT measurements on the broadcast transmissions for the one or more MBS associated with the one or more MTCHs may be indexed (or ordered or organized), in the MDT report, based on the one or more G-RNTIs associated with the one or more MTCHs (and on the one or more cell identifier). In such a case, the MDT report may comprise at least information on results of the one or more MDT measurements, the one or more cell identifiers and the one or more G-RNTIs. In other words, each MDT measurement result (e.g., RSRP and/or RSRQ value) or at least one MDT measurement result may be associated with or tagged to, in the MDT report, a particular cell identifier and a particular G-RNTI.

If the MDT measurements (or at least some of them) are carried out on a per MCCH-RNTI basis as described in connection with block 202, results of the one or more MDT measurements on the broadcast transmissions for the one or more MBS associated with the one or more MCCHs may be indexed (or ordered or organized), in the MDT report, based on the one or more MCCH-RNTIs associated with the one or more MCCHs (and on the one or more cells). In such a case, the MDT report may comprise at least information on results of the MDT measurements, the one or more cell identifiers and the one or more MCCH-RNTIs. In other words, each MDT measurement result (e.g., RSRP and/or RSRQ value) or at least one MDT measurement result may be associated with or tagged to a particular cell identifier and a particular MCCH-RNTI in the MDT report.

In some embodiments, results of the MDT measurements on the broadcast transmissions for the one or more MBS may be indexed (or ordered or organized), in the MDT report, based on at least one MBS delivery mode used for performing the MDT measurements. The information on the used MBS delivery mode(s) may be comprised in the MDT report (tagged to the results of the MDT measurements).

In some embodiments where the MDT measurements in block 202 are radio measurements of reference signal(s) of a pre-defined type (e.g., SSB or TRS), the MDT report transmitted in block 203 may also comprise information on said pre-defined type.

In some embodiments, the MDT report may comprise DL-SCH block error rate (BLER) for the one or more MDT measurements.

In some embodiments, the MDT report may comprise information on at least one carrier frequency used in the one or more MDT measurements (i.e., used in the broadcast transmissions).

In some embodiments, the MDT report may comprise location information (namely, location information of the terminal device at the time of the MDT measurements), time stamps associated with the MDT measurements and/or one or more event or failure records.

Referring to FIG. 2B, the apparatus (i.e., the access node or a part thereof) transmits, in block 211, to a terminal device of a wireless communication network, an MDT measurement configuration for one or more MBS. The MDT measurement configuration defines a configuration for the terminal device for performing MDT measurements on broadcast transmissions for the one or more MBS associated with one or more cells of the wireless communication network and for forming an MDT report for transmission to the access node or another access node of the wireless communication network. Here (and as described in connection with FIG. 2A), the MDT report comprises at least information on results of the MDT measurements of the broadcast transmissions for the one or more MBS. The results of the MDT measurements are indexed, in the MDT report, at least based on one or more cell identifiers of the one or more cells. The one or more cell identifiers may be comprised in the MDT report. The MDT measurement configuration may be transmitted as an RRC message (namely, an RRC LoggedMeasurementConfiguration message).

In general, the MDT measurement configuration transmitted in block 211 may be defined so as to implement any of the embodiments of the terminal device-side as discussed, e.g., in connection with FIG. 2A. For example, the MDT measurement configuration (or specifically said configuration for the terminal device for the performing MDT measurements defined therein) may define one or more of the following:
one or more measurements of RSRP and/or RSRQ based on the broadcast transmissions (e.g., SSB and/or TRF),
one or more MDT measurements on the broadcast transmissions for the one or more MBS associated with one or more MTCHs (the one or more MTCHs being associated, respectively, with one or more G-RNTIs configured to the terminal device)
indexing, in the MDT report, of results of the one or more MDT measurements on the broadcast transmissions for the one or more MBS associated with the one or more MTCHs based on the one or more G-RNTIs associated with the one or more MTCHs,
one or more MDT measurements on the broadcast transmissions for the one or more MBS associated with one or more MCCHs (the one or more MCCHs being associated, respectively, with one or more MCCH-RNTIs configured to the terminal device),
indexing, in the MDT report, of results of the one or more MDT measurements on the broadcast transmissions for the one or more MBS associated with the one or more MCCHs based on the one or more MCCH-RNTIs associated with the one or more MCCHs,
indexing, in the MDT report, of results of the MDT measurements on the broadcast transmissions for the one or more MBS based on MBS delivery mode used for the MDT measurements,
a determination of block error rate to be performed after each received broadcast transmission,
a determination of a number of repetitions needed by the terminal device for decoding at least one transport block of the broadcast transmissions for the one or more MBS and/or an average number of said repetitions,
a determination of a number of unnecessary repetitions of the least one transport block of the broadcast transmissions for the one or more MBS and/or an average number of said unnecessary repetitions (the unnecessary repetitions being received repetitions not needed by the terminal device for decoding said at least one transport block),
one or more first averaging parameters for calculating the average number of the repetitions needed by the terminal device for the decoding the at least one transport block of the broadcast transmissions for the one or more MBS and/or the average number of the unnecessary repetitions of the least one transport block of the broadcast transmissions for the one or more MBS,
a determination of at least one modulation and coding scheme used in decoding of the broadcast transmissions for the one or more MBS,
a determination of an average modulation and coding scheme index used in the decoding of the broadcast transmissions for the one or more MBS and
one or more second averaging parameters for calculating the average modulation and coding scheme index.

The following blocks 212, 213 of FIG. 2B may be considered optional (as indicated by the use of dashed lines). Namely, one or both of the actions relating to blocks 212, 213 may, in some embodiments, be carried out by a different access node to the access node performing the transmitting of the MDT measurement configuration in block 211.

The apparatus broadcasts, in block 212, one or more signals (comprising, e.g., one or more SSBs and/or one or more TRSs) to be measured by the terminal device.

The apparatus receives, in block 213, an MDT report from the terminal device. The MDT may (or may not) comprise results of MDT measurements carried out based on the one or more signals transmitted in block 212. The MDT report may be defined as described in detail in connection with block 203 of FIG. 2A.

The access node may, following the reception of the MDT report in block 213, communicate the MDT report or at least some of the MDT measurement results comprised therein to a core network entity (e.g., a trace collection entity) for enabling optimization of the broadcast transmissions in the wireless communication network. As the results of the MDT measurements are provided at least per cell, the parameters for broadcast transmission in each cell that the terminal device has visited can be separately optimized.

NR broadcasting using MBS delivery mode 2 (DM-2) does not support hybrid automatic repeat request (HARQ) feedback. Therefore, (blind) repetitions may be to be used to improve the decoding performance of broadcast in NR. However, there are no means for the network to know how many (blind) repetitions were needed for the terminal devices to decode the TBs successfully.

For example, the network may have configured 4 (blind) retransmissions (AggregationLevel=4), such that every TB (potentially with different redundancy versions) is transmitted 5 times to the terminal devices. However, it may be that all the terminal devices decode the TB only in 3 transmissions and 2 over 5 transmissions are in general redundant and would decrease spectral efficiency. If the network would know when such situations occur, it could, in the long run, optimize the number of repetitions based on the current channel conditions of the network. The network may also change the MCS, if needed.

FIG. 3 illustrates another process according to embodiments for performing MDT measurements involving repeated broadcast transmissions and reporting thereof for overcoming said problem. The illustrated process may be carried out by a terminal device or a part of the terminal device. Said terminal device be either of terminal devices 100, 102 of FIG. 1. In the following, the entity carrying out the process is called an apparatus for brevity.

Any of the features and definitions provided in connection with FIG. 2A may apply here.

Referring to FIG. 3, the apparatus initially receives, in block 301, an MDT measurement configuration and then performs or causes performing MDT measurements based on broadcast transmissions received from one or more access nodes serving, respectively, one or more cells of a wireless communication network (e.g., a 5G NR wireless communication network), similar to as described in connection with blocks 201, 202 of FIG. 2A.

Here, the performing of the MDT measurements corresponds to blocks 302, 303. It assumed, in this embodiment, that the broadcast transmissions transmitted by one or more access nodes to the terminal device (or to the apparatus) comprise original broadcast transmissions and (blind) repetitions of the original broadcast transmissions. Specifically, one or more (blind) repetitions may be transmitted for each (or at least one) of the original broadcast transmissions.

Accordingly, the apparatus receives, in block 302, a plurality of broadcast transmissions comprising at least some of the original broadcast transmissions and the (blind) repetitions of the original broadcast transmissions transmitted by said one or more access nodes. The plurality of broadcast transmissions may be defined here as discussed in connection with block 202 of FIG. 2A (e.g., each of them may correspond to a transmission of an SSB or a TRS and/or they may be associated with one or more cells, one or more G-RNTI, one or more MCCH-RNTI and/or one or more MBS delivery modes used by the terminal device).

The apparatus decodes, in block 303, at least one transport block (TB) based on the received broadcast transmissions of transport blocks. In other words, for each original broadcast transmission, the decoding may be carried out based on one or more broadcast transmission comprising said original broadcast transmission (if available) and/or zero or more of one or more available (blind) repetitions of said original broadcast transmission. It should be noted that, in some cases, the original broadcast transmission may not be received successfully but one or more of its repetitions may. The number of the zero or more of the one or more available (blind) repetitions used in the decoding may be selected to be the smallest number resulting in successful decoding. The smallest number of (blind) repetitions needed for successful decoding may depend, for example, on signal quality (which, in turn, depends on, e.g., current channel conditions).

In some embodiments, the performing of the MDT measurements (by the apparatus) based on the received MDT measurement configuration (corresponding to block 202 of FIG. 2A and blocks 302, 303 of FIG. 3) may further comprise determining (or performing measurements of) block error rate (BLER) after each (or at least one) received broadcast transmission. Here, the received broadcast transmissions may comprise received original (i.e., initial) broadcast transmission(s) and repetition(s) thereof.

In some embodiments, the performing of the MDT measurements (by the apparatus) based on the received MDT measurement configuration (corresponding to block 202 of FIG. 2A and blocks 302, 303 of FIG. 3) may further comprise determining (or performing measurements of) a number of repetitions needed for decoding the broadcast transmissions for the one or more MBS and/or an average number of said repetitions needed for the decoding of the broadcast transmissions for the one or more MBS. In general, one or more values for the number of repetitions (or at least one average value) may be determined based on the broadcast transmission for the one or more MBS. Additionally or alternatively, said performing of the MDT measurements may comprise determining (or performing measurements of) a number of unnecessary repetitions of the least one transport block of the broadcast transmissions for the one or more MBS and/or an average number of the unnecessary repetitions of the least one transport block of the broadcast transmissions for the one or more MBS. Here, the unnecessary repetitions may be received repetitions not needed for (successful) decoding of said at least one transport block. Also here, one or more values for the number of unnecessary repetitions (or at least one average value) may be determined based on the broadcast transmission for the one or more MBS.

As described above, the averaging for calculating the average number of (blind) necessary or unnecessary repetitions may be carried out according one or more first (averaging) parameters defined in the MDT measurement configuration received from an access node.

In some embodiments, the performing of the MDT measurements (by the apparatus) based on the received MDT measurement configuration (corresponding to block 202 of FIG. 2A and blocks 302, 303 of FIG. 3) may further comprise determining (or performing measurements of) at least one MCS used in decoding of the broadcast transmissions for the one or more MBS. Additionally or alternatively, the performing of the MDT measurements may comprise determining (or performing at least one measurement of) an average MCS index used in the decoding of the broadcast transmissions for the one or more MBS.

As described above, the averaging for determining the average MCS index may be carried out according one or more second (averaging) parameters defined in the MDT measurement configuration received from an access node.

The apparatus transmits or causes transmitting, in block 304, an MDT report to an access node of the wireless communication network (which may or may not be an access node involved in the MDT measurements), similar to block 203 of FIG. 2A. The MDT report comprises at least information on results of the plurality of MDT measurements indexed based on the one or more cell identifiers of the one or more cells associated with the plurality of MDT measurements. In general, the MDT report may comprise any information described in connection with block 203 as being included in the MDT report.

Here, the MDT report further comprises measurement result information relating to the decoding. Namely, the MDT report may comprise:
information on a number or an average number of (blind) repetitions needed for decoding said at least one transport block, and/or
information on a number or an average number of unnecessary (blind) repetitions of a broadcast transmission received but not needed for decoding said at least one transport block.

In some embodiments, the information relating to the decoding may be provided, in the MDT report, per cell, per G-RNTI or MCCH-RNTI, per MCS (index) and/or per MBS delivery mode.

Additionally or alternatively, the MDT report may comprise measurement result information relating to the decoding represented as a BLER measured after each broadcast transmission (i.e., after each received original broadcast transmission and after each received (blind) repetition thereof). In some embodiments, this information may be provided, in the MDT report, per cell, per MCS (index), per G-RNTI or MCCH-RNTI and/or per MBS delivery mode.

In some embodiments, the MDT report may further comprise measurement result information on at least one MCS used in the decoding of said at least one transport block of the broadcast transmissions for the one or more MBS (e.g., comprising at least one MCS index). Additionally or alternatively, the MDT report may further comprise information on an average MCS index of the at least one MCS used in the decoding of said at least one transport block of the broadcast transmissions for the one or more MBS.

The network is able to optimize the number of (blind) repetitions and/or MCS based on the MDT report.

In some embodiments, the apparatus may store (i.e., log) any of the decoding related information described above to a database.

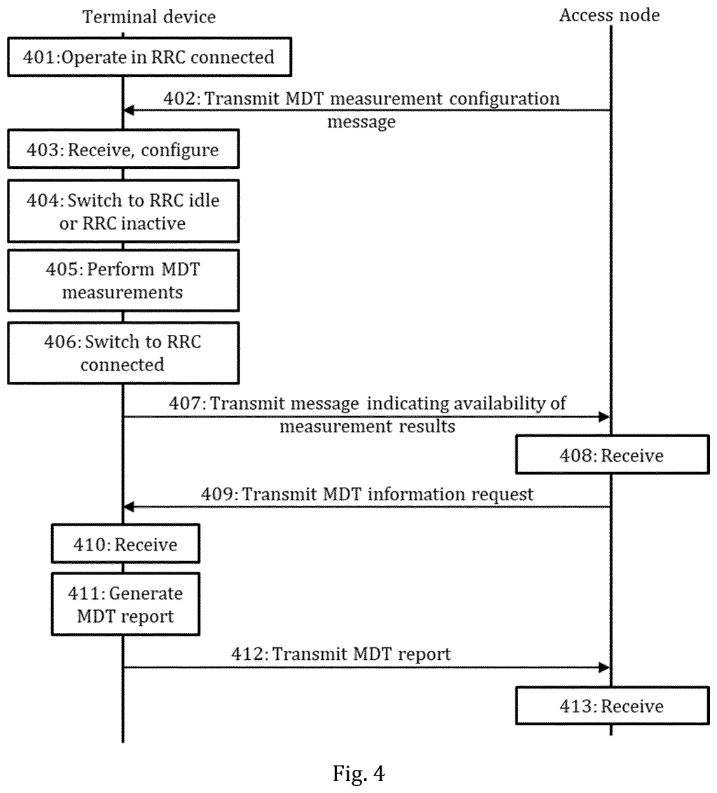

FIG. 4 illustrates signaling between an access node and a terminal device for configuring MDT measurement, performing configured MDT measurements and reporting results of the MDT measurements. The terminal device may be either of terminal devices 100, 102 of FIG. 1 and the access node may be the access node 104 of FIG. 1.

Referring to FIG. 4, it is assumed that initially, in block 401, the terminal device is operating in RRC connected mode. The terminal device may be specifically connected at least to the access node shown in FIG. 4. The access node shown in FIG. 4 may be (initially) the serving access node of the terminal device.

The access node transmits, in message 402, an MDT measurement configuration message defining a configuration for MDT measurements (for one or more MBS) and subsequent MDT reporting to the terminal device, as described in connection with block 201 of FIG. 2. The MDT measurement configuration message may specifically define, here, a logged MDT mode configuration, i.e., a configuration of a second MDT data collection mode (“logged MDT mode”) usable by the terminal devices operating in the RRC idle mode or the RRC inactive mode. The configuration message may, thus, be an RRC LoggedMeasurementConfiguration message. The MDT measurement configuration message (or specifically the RRC LoggedMeasurementConfiguration message) may originate from MBS configuration from Operation and Maintenance (OAM) center of the core network, where the logging is independent of RRC operating mode.

In general, the MDT measurement configuration message (being, e.g., the LoggedMeasurementConfiguration message) may comprise one or more of the following:
A configuration of the triggering of logging events. The parameter specifies the periodicity for storing MDT measurement results. It may be configured in seconds in multiples of the applied RRC idle mode discontinuous reception (DRX), i.e., multiples of 1.28 s which is either a factor or multiple of the RRC idle mode DRX.
A configuration of the logging duration. This configuration parameter defines a timer activated at the moment of configuration. The timer may continue independent of, e.g., RRC operating mode change, RAT change or registered public land mobile network (RPLMN) change. When the timer expires, the logging may be stopped and the configuration may be cleared (except for the parameters that are required for further reporting, e.g., network absolute time stamp, trace reference, trace recording session reference and a target cell identifier, TCE ID).
A network absolute time stamp to be used as a time reference to the terminal device.
A trace reference parameter as indicated by the OAM configuration.
Trace recording session reference as indicated by the OAM configuration.
TCE ID as indicated by the OAM configuration.
MDT public land mobile network (PLMN) list, indicating the PLMNs where measurement collection and log reporting is allowed. It is a subset of the equivalent public land mobile network (EPLMN) list and the RPLMN at logged measurement configuration.
A configuration of a logging area. A terminal device may log measurements as long as it is within the configured logging area (defined, e.g., as a set of cells). The scope of the logging area may consist of one of:
   a list of global cell identities (or identifiers) (e.g., up to 32 global cell identifiers). If this list is configured, the terminal device will only log measurements when camping in any of these cells
   a list of tracking areas (TAs) or location areas (LAs) or routing area (RAs) (e.g., up to 8 TAs, LAs or RAs). If this list is configured, the terminal device will only log measurements when camping in any cell belonging to the preconfigured TA/LA/RAs.
The configured logging area can span PLMNs in the MDT PLMN List. If no area is configured, the terminal device will log measurements throughout the PLMNs of the MDT PLMN list.

The terminal device receives, in block 403, the MDT measurement configuration message and configures, also in block 403, itself according to the MDT measurement configuration message.

The terminal device switches, in block 404, from the RRC connected mode to RRC inactive or idle mode. While not explicitly shown in FIG. 4, said switching may comprise communication between the terminal device and the access node (e.g., at least transmission of a RRC release message from the access node to the terminal device). Subsequently while operating in the RRC inactive or idle mode, the terminal device performs (and logs), in block 405, MDT measurements based on broadcast transmissions received from one or more access nodes serving, respectively, one or more cells of a wireless communication network according to the (logged MDT) configuration defined via the configuration message. Said one or more access nodes may or may not comprise the access node of FIG. 4. The one or more MDT measurements may be performed as described in connection with block 202 of FIG. 2 and/or blocks 302, 303 of FIG. 3 above.

The terminal device switches, in block 406, back to the RRC connected mode. While not explicitly shown in FIG. 4, said switching in block 406 may comprise completing an RRC connection establishment procedure involving communication between the terminal device and the access node.

Upon switching back to the RRC connected mode in block 406, the terminal device transmits, in message 407, to the access node, a message comprising an indication informing the access node that logged MDT data is available (i.e., results of the MDT measurements are available and thus an MDT report may be transmitted upon request). The message 407 may be an RRC setup complete message.

Upon receiving the message comprising the indication in block 408, the access node transmits, in message 409, an MDT information request to the terminal device (for requesting transmission of an MDT report).

Upon receiving the MDT information request in block 410, the terminal device generates or forms, in block 411, an MDT report according to the MDT measurement configuration defined via the configuration message 402 and based on logged measurement information and subsequently transmits, in block 412, the MDT report to the access node. In other embodiments, the MDT report may be generated already before the transmitting of message 407.

The access node receives, in block 413, the MDT report from the terminal device.

While it was assumed in FIG. 4 that the MDT measurements are performed while the terminal device operates in the RRC idle or inactive mode, in other embodiments (as described also in connection to FIG. 2), the MDT measurements (or at least some of them) may be carried out by the terminal device while operating in the RRC connected mode. In such embodiments, the MDT report may be generated and transmitted to the serving access node directly following the performing of the MDT measurements (or periodically or upon request by the access node). In other words, in such embodiments, the reporting of the results of MDT measurements is not necessarily delayed like in the embodiment of FIG. 4 where the terminal device had to, first, switch to the RRC connected mode before any MDT reporting could be carried out. Such embodiments may correspond to the process of FIG. 4 with (at least) blocks 404, 406 omitted.

While FIG. 4 illustrates a case where the access node which configures the terminal device (with message 402) is the same as the access node which is informed of measurement results and requests and receives the MDT report (with elements 407 to 413), in other embodiments, two different access nodes may perform said functionalities. One, both or neither of these two access nodes may be involved in the MDT measurements carried out in block 405.

The blocks, related functions, and information exchanges (messages) described above by means of FIGS. 2A, 2B, 3 and 4 in no absolute chronological order, and some of them may be performed simultaneously or in an order differing from the given one. Other functions can also be executed between them or within them, and other information may be sent, and/or other rules applied. Some of the blocks or part of the blocks or one or more pieces of information can also be left out or replaced by a corresponding block or part of the block or one or more pieces of information.

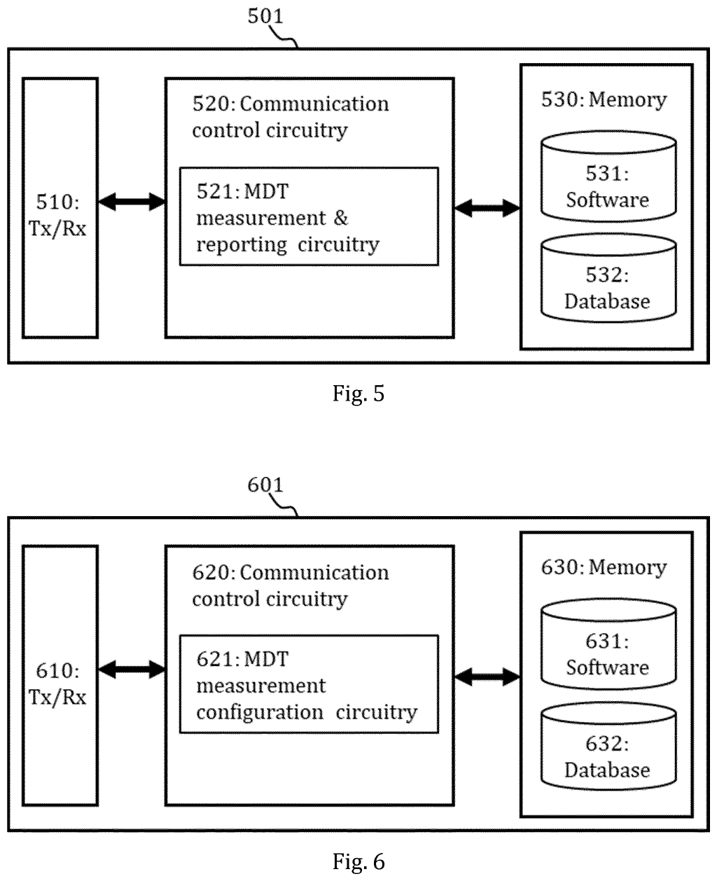

FIG. 5 illustrates an apparatus 501 according to some embodiments. Specifically, FIG. 5 may illustrate an apparatus 501 for a terminal device (i.e., forming a part of a terminal device) or an apparatus 501 which is a terminal device or comprises a terminal device. In either case, the terminal device in question may be either of the terminal devices 100, 102 of FIG. 1.

The apparatus 501 may comprise one or more control circuitry 520, such as at least one processor, and at least one memory 530, including one or more algorithms 531, such as a computer program code (software) wherein the at least one memory and the computer program code (software) are configured, with the at least one processor, to cause the apparatus to carry out any one of the exemplified functionalities of the apparatus (or the terminal device) described above. Said at least one memory 530 may also comprise at least one database 532.

Referring to FIG. 5, the one or more communication control circuitry 520 of the apparatus 501 comprise at least MDT measurement & reporting circuitry 521 which is configured to perform MDT measurements as well as reporting of results of said MDT measurements (in the form of an MDT report) to an access node. To this end, the MDT measurement & reporting circuitry 521 of the apparatus 501 is configured to carry out at least some of the functionalities of the apparatus (or terminal device) described above, e.g., by means of FIG. 2A and/or 3 and/or elements 401, 403 to 407, 410 and/or 411 of FIG. 4, using one or more individual circuitries.

Referring to FIG. 5, the memory 530 may be implemented using any suitable data storage technology, such as semiconductor based memory devices, flash memory, magnetic memory devices and systems, optical memory devices and systems, fixed memory and removable memory.

Referring to FIG. 5, the apparatus 501 may further comprise different interfaces 510 such as one or more communication interfaces (TX/RX) comprising hardware and/or software for realizing communication connectivity according to one or more communication protocols. Specifically, the one or more communication interfaces 510 may comprise, for example, interfaces providing a connection to the Internet and a core network of a wireless communications network. The one or more communication interface 510 may provide the apparatus with communication capabilities to communicate in a cellular communication system and enable communication between other terminal devices and different network nodes or elements (e.g., access nodes). The one or more communication interfaces 510 may comprise standard well-known components such as an amplifier, filter, frequency-converter, (de)modulator, and encoder/decoder circuitries, controlled by the corresponding controlling units, and one or more antennas.

FIG. 6 illustrates an apparatus 601 according to some embodiments. Specifically, FIG. 6 may illustrate an apparatus 601 for an access node (i.e., forming a part of an access node) or an apparatus 601 which is an access node or comprises an access node. In either case, the access node in question may be the access node 104 of FIG. 1.

The apparatus 601 may comprise one or more control circuitry 620, such as at least one processor, and at least one memory 630, including one or more algorithms 631, such as a computer program code (software) wherein the at least one memory and the computer program code (software) are configured, with the at least one processor, to cause the apparatus to carry out any one of the exemplified functionalities of the apparatus (or the access node) described above. Said at least one memory 630 may also comprise at least one database 632.

Referring to FIG. 6, the one or more communication control circuitry 620 of the apparatus 601 comprise at least MDT measurement configuration circuitry 621 which is configured to perform MDT measurement configuration of a terminal device. To this end, the MDT measurement configuration circuitry 621 of the apparatus 601 is configured to carry out at least some of the functionalities of the apparatus (or access node) described above, e.g., by means of FIG. 2B and/or elements 408, 409, 413 of FIG. 4, using one or more individual circuitries.

Referring to FIG. 6, the memory 630 may be implemented using any suitable data storage technology, such as semiconductor based memory devices, flash memory, magnetic memory devices and systems, optical memory devices and systems, fixed memory and removable memory.

Referring to FIG. 6, the apparatus 601 may further comprise different interfaces 610 such as one or more communication interfaces (TX/RX) comprising hardware and/or software for realizing communication connectivity according to one or more communication protocols. Specifically, the one or more communication interfaces 610 may comprise, for example, interfaces providing a connection to the Internet and a core network of a wireless communications network. The one or more communication interface 610 may provide the apparatus with communication capabilities to communicate in a cellular communication system and enable communication to terminal devices and different network nodes or elements (e.g., other access nodes). The one or more communication interfaces 610 may comprise standard well-known components such as an amplifier, filter, frequency-converter, (de) modulator, and encoder/decoder circuitries, controlled by the corresponding controlling units, and one or more antennas.

As used in this application, the term ‘circuitry’ may refer to one or more or all of the following: (a) hardware-only circuit implementations, such as implementations in only analog and/or digital circuitry, and (b) combinations of hardware circuits and software (and/or firmware), such as (as applicable): (i) a combination of analog and/or digital hardware circuit(s) with software/firmware and (ii) any portions of hardware processor(s) with software, including digital signal processor(s), software, and memory (ies) that work together to cause an apparatus, such as a terminal device or an access node, to perform various functions, and (c) hardware circuit(s) and processor(s), such as a microprocessor(s) or a portion of a microprocessor(s), that requires software (e.g. firmware) for operation, but the software may not be present when it is not needed for operation. This definition of ‘circuitry’ applies to all uses of this term in this application, including any claims. As a further example, as used in this application, the term ‘circuitry’ also covers an implementation of merely a hardware circuit or processor (or multiple processors) or a portion of a hardware circuit or processor and its (or their) accompanying software and/or firmware. The term ‘circuitry’ also covers, for example and if applicable to the particular claim element, a baseband integrated circuit for an access node or a terminal device or other computing or network device.

In an embodiment, at least some of the processes described in connection with FIGS. 2A, 2B, 3 and 4 may be carried out by an apparatus comprising corresponding means for carrying out at least some of the described processes. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry. In an embodiment, the at least one processor, the memory, and the computer program code form processing means or comprises one or more computer program code portions for carrying out one or more operations according to any one of the embodiments of FIGS. 2A, 2B, 3 and 4 or operations thereof.

According to an embodiment, there is provided an apparatus (for a terminal device), the apparatus comprising means for:
receiving from an access node of the wireless communication network, minimization of drive tests, MDT, measurement configuration for one or more multicast and broadcast services, MBS;
performing MDT measurements on broadcast transmissions for the one or more MBS associated with one or more cells of the wireless communication network based on the received MDT measurement configuration; and
transmitting an MDT report, formed based on the received MDT measurement configuration, to the access node or to another access node of the wireless communication network, wherein the MDT report comprises at least information on results of the MDT measurements on the broadcast transmissions for the one or more MBS, and wherein the results of the MDT measurements are indexed, in the MDT report, based on one or more cell identifiers of the one or more cells.

According to an embodiment, there is provided an apparatus (for an access node), the apparatus comprising means for:
transmitting, to a terminal device of a wireless communication network, an MDT measurement configuration for one or more MBS, wherein the MDT measurement configuration defines a configuration for the terminal device for performing MDT measurements on broadcast transmissions for the one or more MBS associated with one or more cells of the wireless communication network and forming an MDT report for transmission to the access node or another access node of the wireless communication network, the MDT report comprising at least information on results of the MDT measurements of the broadcast transmissions for the one or more MBS, the results of the MDT measurements being indexed, in the MDT report, based on one or more cell identifiers of the one or more cells.

Embodiments as described may also be carried out in the form of a computer process defined by a computer program or portions thereof. Embodiments of the methods described in connection with FIGS. 2A, 2B, 3 and 4 may be carried out by executing at least one portion of a computer program comprising corresponding instructions. The computer program may be provided as a computer readable medium comprising program instructions stored thereon or as a non-transitory computer readable medium comprising program instructions stored thereon. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium. Coding of software for carrying out the embodiments as shown and described is well within the scope of a person of ordinary skill in the art.

Even though the embodiments have been described above with reference to examples according to the accompanying drawings, it is clear that the embodiments are not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An apparatus for a terminal device of a wireless communication network, the apparatus comprising:
at least one processor; and
at least one memory including computer program code;
the at least one memory and the computer program code configured, with the at least one processor, to cause the apparatus at least to perform:
receiving from an access node of the wireless communication network, minimization of drive tests, MDT, measurement configuration for one or more multicast and broadcast services, MBS;
performing MDT measurements on broadcast transmissions for the one or more MBS associated with one or more cells of the wireless communication network based on the received MDT measurement configuration; and
transmitting an MDT report, formed based on the received MDT measurement configuration, to the access node or to another access node of the wireless communication network, wherein the MDT report comprises at least information on results of the MDT measurements on the broadcast transmissions for the one or more MBS, and wherein the results of the MDT measurements are indexed, in the MDT report, based on one or more cell identifiers of the one or more cells.

2. The apparatus of claim 1, wherein the at least one memory and the computer program code are configured, with the at least one processor, to cause the apparatus to perform the MDT measurements based on the received MDT measurement configuration by at least:
performing measurements of reference signal received power, RSRP, and/or reference signal received quality, RSRQ, based on the broadcast transmissions, wherein the broadcast transmissions comprise one or more reference signals of a pre-defined type.

3. The apparatus of claim 2, wherein the pre-defined type is a synchronization signal block or a tracking reference signal.

4. The apparatus of claim 2, wherein the MDT report comprises information on the pre-defined type of the one or more reference signals associated with the measurements of the RSRP and/or RSRQ.

5. The apparatus according to claim 1, wherein the MDT measurements on the broadcast transmissions for the one or more MBS comprise:
one or more MDT measurements on the broadcast transmissions for the one or more MBS associated with one or more multicast traffic channels, MTCHs, wherein the one or more MTCHs are associated, respectively, with one or more group radio network temporary identifiers, G-RNTIs, configured to the terminal device.

6. The apparatus of claim 5, wherein results of the one or more MDT measurements on the broadcast transmissions for the one or more MBS associated with the one or more MTCHs are indexed, in the MDT report, based on the one or more G-RNTIs associated with the one or more MTCHs.

7. The apparatus according to claim 1, wherein the MDT measurements on the broadcast transmissions for the one or more MBS comprise:
one or more MDT measurements on the broadcast transmissions for the one or more MBS associated with one or more multicast control channels, MCCHs, wherein the one or more MCCHs are associated, respectively, with one or more multicast control channel radio network temporary identifiers, MCCH-RNTIs, configured to the terminal device.

8. The apparatus of claim 7, wherein results of the one or more MDT measurements on the broadcast transmissions for the one or more MBS associated with the one or more MCCHs are indexed, in the MDT report, based on the one or more MCCH-RNTIs associated with the one or more MCCHs.

9. The apparatus according to claim 1, wherein the results of the MDT measurements on the broadcast transmissions for the one or more MBS are indexed, in the MDT report, based on MBS delivery mode used for the MDT measurements.

10. The apparatus according to claim 1, wherein the at least one memory and the computer program code are configured, with the at least one processor, to cause the apparatus to perform the MDT measurements based on the received MDT measurement configuration by at least:
determining block error rate after each received broadcast transmission.

11. The apparatus according to claim 1, wherein the at least one memory and the computer program code are configured, with the at least one processor, to cause the apparatus to perform the MDT measurements based on the received MDT measurement configuration by at least:
determining a number of repetitions needed for decoding at least one transport block of the broadcast transmissions for the one or more MBS and/or an average number of said repetitions, and/or
determining a number of unnecessary repetitions of the least one transport block of the broadcast transmissions for the one or more MBS and/or an average number of said unnecessary repetitions, the unnecessary repetitions being received repetitions not needed for decoding said at least one transport block.

12. The apparatus according to claim 11, wherein the MDT measurement configuration comprises one or more first averaging parameters for calculating the average number of the repetitions needed for the decoding the at least one transport block of the broadcast transmissions for the one or more MBS and/or the average number of the unnecessary repetitions of the least one transport block of the broadcast transmissions for the one or more MBS.

13. The apparatus according to claim 1, wherein the at least one memory and the computer program code are configured, with the at least one processor, to cause the apparatus to perform the MDT measurements based on the received MDT measurement configuration by at least:
determining at least one modulation and coding scheme used in decoding of the broadcast transmissions for the one or more MBS; and/or
determining an average modulation and coding scheme index used in the decoding of the broadcast transmissions for the one or more MBS.

14. The apparatus of claim 13, wherein the MDT measurement configuration comprises one or more second averaging parameters for calculating the average modulation and coding scheme index.

15. The apparatus according to claim 1, wherein the MDT measurement configuration is comprised in a radio resource control message.

16. The apparatus according to claim 1, wherein the at least one memory and the computer program code are configured, with the at least one processor, to cause the apparatus to perform the MDT measurements on the broadcast transmissions for the one or more MBS when the terminal device is operating in a radio resource control connected mode.

17. The apparatus according to claim 1, wherein the at least one memory and the computer program code are configured, with the at least one processor, to cause the apparatus to
perform the MDT measurements on the broadcast transmissions for the one or more MBS when the terminal device is operating in a radio resource control idle or inactive mode; and
transmit the MDT report following switching of the terminal device from the radio resource control idle or inactive mode to a radio resource control connected mode.

18. The apparatus according to claim 1, wherein the at least one memory and the computer program code are configured, with the at least one processor, to cause the apparatus to perform the transmitting of the MDT report in response to receiving an MDT information request from the access node or said another access node of the wireless communication network when the terminal device is operating in a radio resource control connected mode.

19. An apparatus for an access node of a wireless communication network, the apparatus comprising:
at least one processor; and
at least one memory including computer program code;
the at least one memory and the computer program code configured, with the at least one processor, to cause the apparatus at least to perform:
transmitting, to a terminal device of the wireless communication network, an MDT measurement configuration for one or more MBS, wherein the MDT measurement configuration defines a configuration for the terminal device for performing MDT measurements on broadcast transmissions for the one or more MBS associated with one or more cells of the wireless communication network and forming an MDT report for transmission to the access node or another access node of the wireless communication network, the MDT report comprising at least information on results of the MDT measurements of the broadcast transmissions for the one or more MBS, the results of the MDT measurements being indexed, in the MDT report, based on one or more cell identifiers of the one or more cells.

20. The apparatus of claim 19, wherein the configuration for the terminal device for the performing of the MDT measurements defines one or more measurements of reference signal received power, RSRP, and/or reference signal received quality, RSRQ, based on the broadcast transmissions, wherein the broadcast transmissions comprise one or more reference signals of a pre-defined type.

21-39. (canceled)
